(19) United States
(12) Patent Application Publication
(10) Pub. No.: US 2016/0004755 A1
(43) Pub. Date: Jan. 7, 2016

(54) INFORMATION PROVIDING DEVICE, INFORMATION PROVIDING PROGRAM, INFORMATION PROVIDING SERVER, AND INFORMATION PROVIDING METHOD

(71) Applicant: MITSUBISHI ELECTRIC CORPORATION, Chiyoda-ku, Tokyo (JP)

(72) Inventor: Tsuyoshi SEMPUKU, Tokyo (JP)

(73) Assignee: MITSUBISHI ELECTRIC CORPORATION, Tokyo (JP)

(21) Appl. No.: 14/769,318

(22) PCT Filed: Jun. 21, 2013
(86) PCT No.: PCT/JP2013/067095

§ 371 Date: Aug. 20, 2015

(51) Int. Cl. G06F 17/30

(52) U.S. Cl. CPC G06F 17/30554; G06F 17/3053; G06F 17/30469; G06F 17/30687; G06F 17/30705

(57) ABSTRACT

An information providing device includes: a device management unit acquiring information of a connected device; a history database storing the information acquired by the device management unit as a history; a function estimation unit estimating a function to be presented to a user, based on the information of the connected device and the history stored in the history database; an availability determination unit determining availability of the function estimated by the function estimation unit; and an output unit outputting the function to be presented to the user, based on an indication of the function estimation unit. The function estimation unit confirms that the estimated function is a function to be presented to the user and causes the output unit to output the function when the availability determination unit determines that the estimated function is available.

### TECHNICAL FIELD

The present invention relates to an information providing device that estimates the purpose of a user, and provides the user with a function to implement the corresponding purpose of operation.

### BACKGROUND ART

Conventionally, as this type of equipment, there has been an information providing device that provides a function registered in advance. With the information providing device, a function used frequently can be realized such that when the function preferred by a user is registered in advance, the user selects the corresponding registered function.

For example, Patent Document 1 discloses an information providing device that satisfies the preference of a user in accordance with the purpose of the user. In that device, the purpose of the user under a certain situation is estimated based on the traveling history. Then, all information relating to a function with a possibility of being provided is acquired, and traveling history information corresponding to the estimated purpose of the user is acquired. After that, based on the operation history corresponding to the estimated purpose of the user, an unnecessary function is deleted from the functions with the possibility of being provided to thereby create a function to be presented.

### CITATION LIST

### Patent Document

Patent Document 1: Japanese Patent Application Laid-open No. 2004-108865

### SUMMARY OF THE INVENTION

### Problems to be Solved by the Invention

However, in the conventional information providing device as disclosed in Patent Document 1, all the information relating to the function with the possibility of being provided is acquired, and processing load for acquiring the information is not considered. Therefore, it suffices for a case where there are few function candidates to be provided to the user or a case where there is a small amount of information relating to the functions to be provided to the user; however, in the case where a large number of function candidates with the possibility of being provided exist or in the case where a large amount of information relevant to each function candidate exists, there is a problem such that both of processing of extracting these pieces of information and processing of deleting unnecessary information and/or functions therefrom need time.

For example, consider a case where the user presents a desired facility from among facilities in the vicinity of a host vehicle. A large amount of processing time is required only for searching and acquiring an optional store brand of a gasoline station existing in the vicinity of the host vehicle. However, there are numerous types of actual facilities other than the gasoline station, and a vast amount of processing time is required to acquire all the information of the facilities in the vicinity of the host vehicle every time the host vehicle travels.

For this reason, it is difficult to present the function with good timing in response to the situation of the vehicle that changes continuously.

In addition, in Patent Document 1, it is silent on a case where no information corresponding to the purpose of the user is included in the information relating to the function with the possibility of being provided. Therefore, there is a problem such that it is not considered as to what function is to be presented to the user when there is no information corresponding to the purpose of the user.

The present invention is made in order to solve the conventional problems described above, and an object of the invention is to provide an information providing device that estimates the purpose of operation by the user and provides the user with a function to realize that purpose of operation, the function being provided to the user efficiently.

### Means for Solving the Problems

An information providing device of the present invention includes: a device manager that acquires information of a connected device; a history database that stores the information acquired by the device manager as a history; a function estimator that estimates a function to be presented to a user, based on the information of the connected device and the history stored in the history database; an availability determinator that determines availability of the function estimated by the function estimator; and an output processor that outputs the function to be presented to the user, wherein the function estimator confirms that the estimated function is the function to be presented to the user, and outputs that function to the output processor when the availability determinator determines that the estimated function is available.

### Effect of the Invention

According to the invention, in the information providing device that estimates the purpose of the user and provides the user with a function to realize that purpose of operation, there is an advantageous effect that efficient processing is possible even in the case where a vast amount of information relevant to a function desired by the user exists, and that the function can be presented with good timing in response to a change in the situation of a vehicle that changes continuously.

### BRIEF DESCRIPTION OF THE DRAWINGS

FIG. 1 is a block diagram showing a configuration of a main part of an information providing device of Embodiment 1 of the present invention.

FIG. 2 is a flowchart for illustrating a main operation of the information providing device of Embodiment 1.

FIG. 3 includes diagrams showing an example of information acquired by a device management unit.

FIG. 4 is a flowchart illustrating a detailed operation in selection of a candidate of function and availability determination therefor by a function estimation unit and an availability determination unit in Embodiment 1.

FIG. 5 is a diagram showing an example of a table of function candidates prepared and stored in advance by the function estimation unit.

FIG. 6 is a flowchart of an operation in the determination of availability of the function candidate by the availability determination unit in Embodiment 1.

FIG. 7 is a diagram representing an example of a device and necessary information corresponding to each function candidate.

FIG. 8 is a diagram showing an example of a determination reference specifying a usage condition with respect to each function candidate.

FIG. 9 is a block diagram showing a configuration of a main part of an information providing device of Embodiment 2 of the invention.

FIG. 10 is a flowchart for illustrating a main operation of the information providing device of Embodiment 2.

FIG. 11 is a flowchart illustrating a detailed operation in selection of a candidate of function and availability determination therefor by a function selection unit and an availability determination unit in Embodiment 2.

FIG. 12 is a diagram showing an example of an estimation result acquired from a purpose estimation unit.

FIG. 13 is a diagram showing an example of a table prepared and stored in advance by the function selection unit.

FIG. 14 is a flowchart illustrating a detailed operation in selection of a candidate of function and availability determination therefor by a function estimation unit and an availability determination unit in Embodiment 3.

FIG. 15 is a flowchart illustrating a detailed operation in selection of a candidate of function and availability determination therefor by a function estimation unit and an availability determination unit in Embodiment 4.

FIG. 16 is a flowchart illustrating an operation of monitoring whether or not a function candidate determined as unavailable is available later.

FIG. 17 is a diagram showing an outline of a navigation system in Embodiment 5.

### MODES FOR CARRYING OUT THE INVENTION

Hereinafter, embodiments of the present invention will be described according to the accompanying drawings.

### Embodiment 1

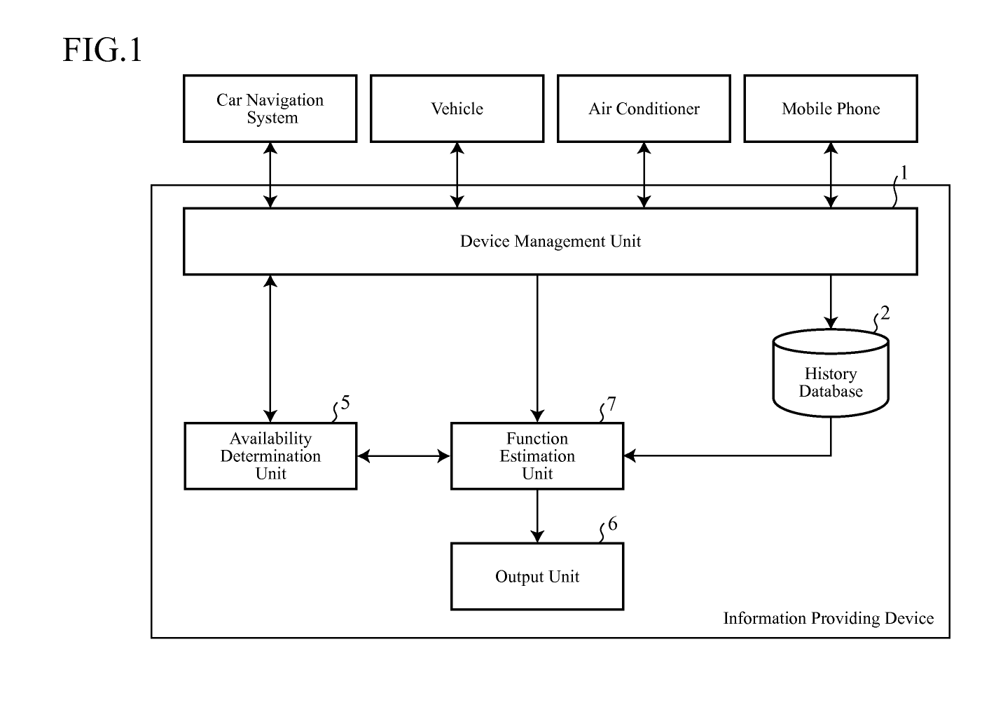

FIG. 1 is a block diagram showing a configuration of a main part of an information providing device of Embodiment 1 of the present invention.

As shown in FIG. 1, the information providing device is connected with devices such as a car navigation system, a vehicle, an air conditioner, a mobile phone, and so on, and includes a device management unit 1, a history database 2, a function estimation unit 7, an availability determination unit 5, and an output unit 6.

The device management unit 1 acquires information from the devices such as the car navigation system, the vehicle, the air conditioner, and the mobile phone connected to the information providing device, and manages the information of the devices. In addition, from the acquired information of the device, a change in a state of the device such as operation environment is detected. With the history database 2, the information acquired by the device management unit 1 from the device connected to the information providing device is recorded as a history. The function estimation unit 7 selects a function candidate to be presented to a user under the situation, based on the information of the history database 2 and the information of the device acquired from the device that is connected with the device management unit 1. The availability determination unit 5 determines the availability of the function candidate selected by the function estimation unit 7. The output unit 6 displays a confirmed function on a display screen or outputs the function through sound.

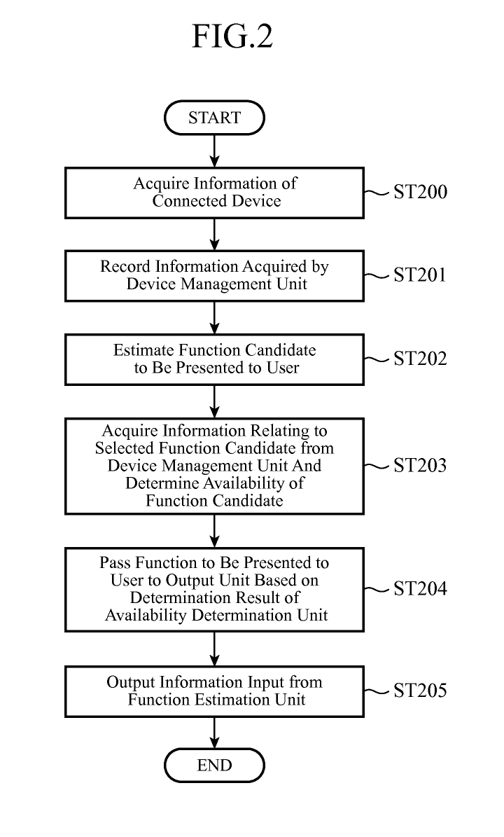

FIG. 2 is a flowchart for illustrating a main operation of the information providing device of Embodiment 1.

When the information providing device starts operating, the device management unit 1 acquires the information from the connected device (step ST200).

For example, the information of ignition, gear, and so on is acquired from the vehicle; the operation information, information of a set route, map information on the vicinity of a current position, and so on are acquired from the car navigation system installed inside the vehicle; and the information for identifying an individual, information of an telephone directory, and so on are acquired from the mobile phone connected through a wireless communication line.

Incidentally, the device management unit 1 may acquire, via a device such as an engine control unit (ECU), the information from the device connected to the ECU.

Then, the device management unit 1 records the information acquired in step ST200 in the history database 2 as the history (step ST201).

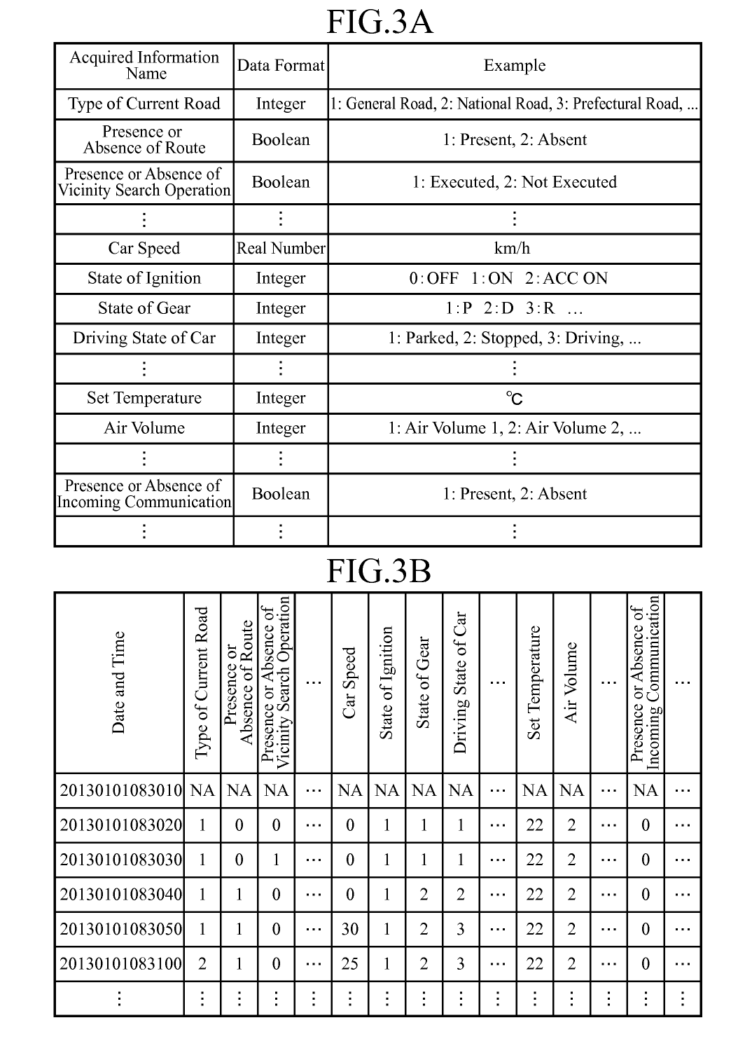

FIG. 3 includes diagrams showing an example of the information acquired by the device management unit 1. FIG. 3(A) shows a data format corresponding to each piece of information. For example, the type of a current road is given an ID number with an integer: 1 represents a general road, and 2 represents a national road. For the presence or absence of a route, 1 represents present, and 2 represents absent. FIG. 3(B) is an example in which a change in each piece of information is recorded in the history database 2. For example, a date 20130101083010 represents 8:30:10 on Jan. 1, 2013. Since that time is the one immediately after the start of an engine, a null value is recorded as NA for each piece of information. After that, at 20130101083020 (8:30:20 on Jan. 1, 2013), the state of the ignition was 1, and the start of the engine is recorded as the history. In this manner, respective information values are recorded in time series.

Additionally, in this step ST201, the device management unit 1 may combine the plurality of pieces of information acquired in step ST200 to generate new information and record the resultant in the history database 2. For example, from information of car speed and state of gear, the driving state of a car is generated. The running state of the car is based on the following manner: when the car speed is 0, it is determined as parking of 1 if the gear is in P, and it is determined as stopping of 2 if the gear is in D.

In addition, if a database corresponding to the history database 2 exists in the device such as the vehicle or car navigation system, the database may be utilized.

Incidentally, in this context, description is given below on the assumption that the history has already been accumulated to some extent in the history database 2; however, it may be configured such that when general information is stored in advance as the history, it is used. Alternatively, in the case where the history is not accumulated sufficiently in the history database 2 at the initial stage, the processing in step ST200 to step ST201 may be repeated until the history is accumulated to some extent.

The function estimation unit 7 estimates the function candidate to be presented to the user based on the information of the history database 2 and the information of the connected device acquired in step ST200 by the device management unit 1 (step ST202). The estimated function candidate is output to the availability determination unit 5.

Specifically, the function estimation unit 7 estimates the function candidate of the user under the situation from the information of the history database 2 and the information of the device acquired in step ST200 by the device management unit 1.

After that, the availability determination unit 5 acquires, from the device management unit 1, the information corresponding to the function candidate acquired from the function estimation unit 7 in step ST202 and determines the availability of the function candidate selected by the function estimation unit 7 in step ST202 (step ST203). Specifically, the availability determination unit 5 first makes a request to the device management unit 1 for the information corresponding to the function candidate acquired from the function estimation unit 7. The device management unit 1 acquires necessary information from the connected device based on the request from the availability determination unit 5 and outputs the acquired information to the availability determination unit 5. Based on the acquired information, the availability determination unit 5 determines the availability of the function acquired from the function estimation unit 7 and outputs the result to the function estimation unit 7.

Subsequently, the function estimation unit 7 determines the function to be presented to the user based on the availability result acquired from the availability determination unit 5 in step ST203 and outputs it to the output unit 6 (step ST204).

The output unit 6 outputs it by a screen display or sound (step ST205) according to the content acquired from the function estimation unit 7 in step ST204, and the operation is ended.

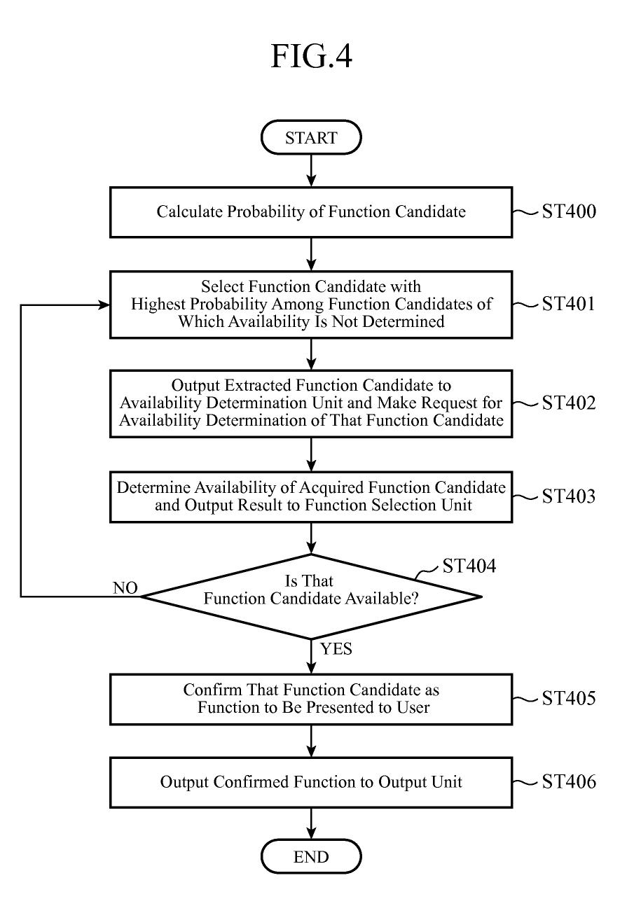

FIG. 4 is a flowchart illustrating a detailed operation in the selection of the candidate of function and the availability determination therefor by the function estimation unit 7 and the availability determination unit 5. Specifically, the processing in step ST202 to step ST204 in FIG. 2 is illustrated in detail.

The function estimation unit 7 estimates the function candidates and calculates the probabilities thereof (step ST400), based on the information of the history database 2 and the information of the connected device acquired from the device management unit 1.

Additionally, for the calculation of the degree of likelihood, it suffices to use a known method, e.g., conditional probability such as the Bayes' theorem. It is not limited thereto.

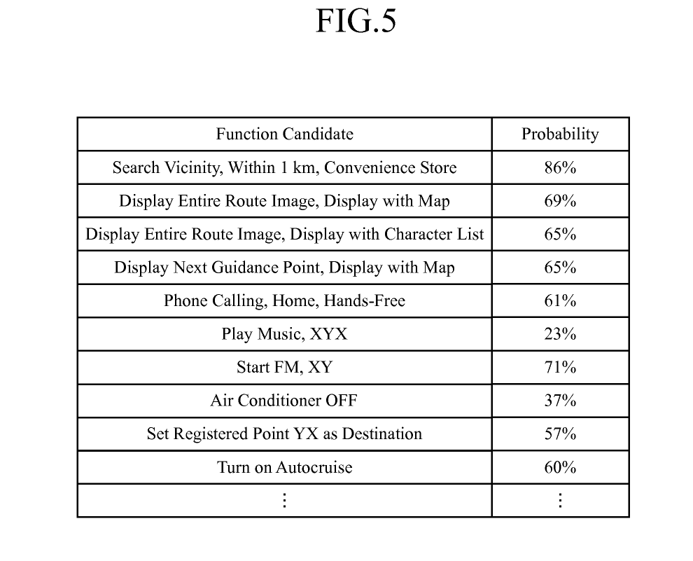

FIG. 5 is a diagram showing an example of a table of function candidates prepared and stored in advance by the function estimation unit 7. The probabilities calculated by the function estimation unit 7 are given and described. For example, as shown in FIG. 5, the probability of being desired by the user is calculated to each function candidate in the following manner: for example, 86% probability for a function candidate “search vicinity, within 1 km, convenience store.” Note that in the description below, the function candidates of No. 11 and after omitted in FIG. 5 are assumed as only function candidates with a probability below 30%.

Additionally, the function to be selected may be a case of the function itself such as “search vicinity,” and a case expressed using a parameter upon executing the function such as “within 1 km”; however, there exists also a case where a parameter is not given like No. 6 “air conditioner OFF” in FIG. 5.

Return to the flow in FIG. 4.

The function estimation unit 7 selects a function candidate with the highest probability among the probabilities calculated in step ST400 (step ST401). For example, in the example of the estimation result in FIG. 5, the probability of the function candidate “search vicinity, within 1 km, convenience store” is the highest at 86%, and therefore the function candidate “search vicinity, within 1 km, convenience store” is selected as a target of performing the availability determination.

Additionally, when the probabilities of the function candidates are the same (e.g., “display entire route image, display with character list” and “display next guidance point, display with map” in FIG. 5), it may be configured such that the operation history of the history database is referenced and a function candidate with the highest operation frequency is selected, or it may be configured such that an optional one is selected.

In addition, in the processing in step ST401, when transition from step ST404 described later is executed, a function candidate with the highest probability among the function candidates excluding the function candidate of which the availability determination is performed is selected as the target of performing the availability determination. For example, if the availability determination to the function candidate “search vicinity, within 1 km, convenience store” has already been performed, the availability determination is performed to a function candidate “start FM, XY” with the second highest probability.

The function estimation unit 7 outputs the function candidate with the highest probability to the availability determination unit 5 and makes a request for the availability determination of the selected function candidate (step ST402).

For example, the function candidate “search vicinity, within 1 km, convenience store” with the highest probability in the example in FIG. 5 is output to the availability determination unit 5.

Accordingly, it is possible to deal with a case where the function candidate with the highest probability is unavailable, and an inappropriate function presentation can be prevented from being performed to the user. Moreover, since the determination is not performed to all the function candidates and the determination proceeds from a function candidate with a higher probability, efficient processing is possible.

The availability determination unit 5 performs the availability determination of the function candidate acquired from a function estimation unit 7 in step ST402 (step ST403).

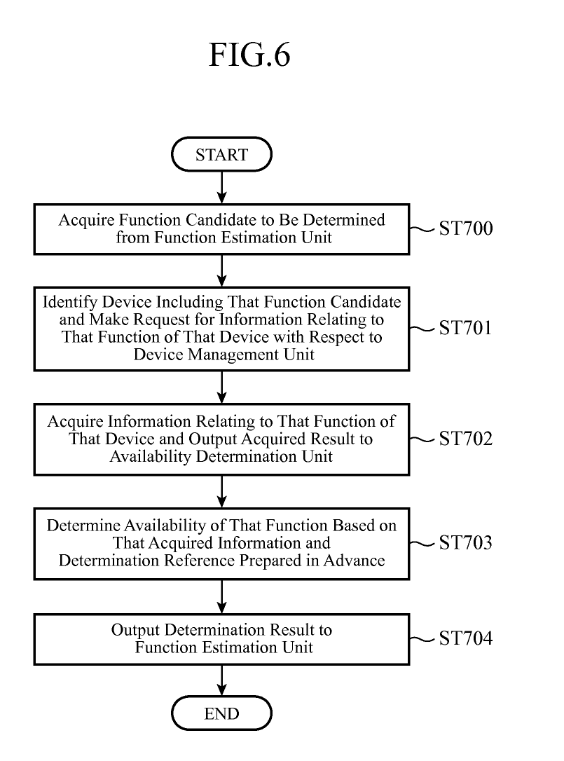

In this connection, FIG. 6 is a flowchart of operations in the availability determination of the function candidate by the availability determination unit 5. The operation of the availability determination unit 5 will be described in detail with reference to FIG. 6.

Note that FIG. 6 corresponds to step ST203 in FIG. 2 and step ST403 in FIG. 4 and illustrates the processing in detail.

Upon acquiring the function candidate to be determined from the function estimation unit 7 (step ST700), the availability determination unit 5 identifies the device including the acquired function candidate and makes a request for the information relating to the acquired function candidate to the device management unit 1 (step ST701).

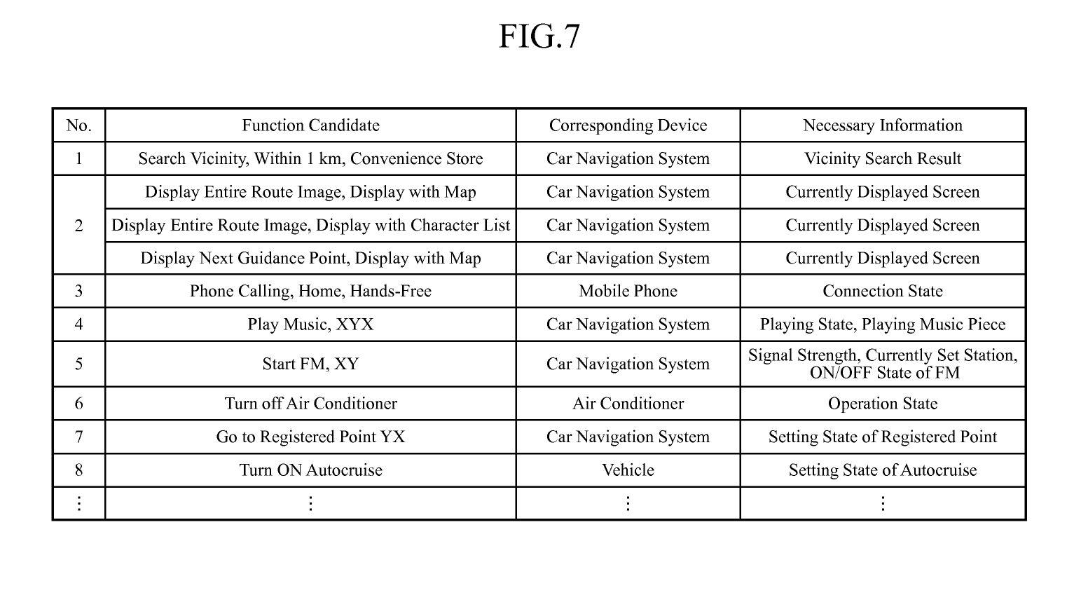

Specifically, the availability determination unit 5 stores information specifying each function candidate as well as a device and necessary information corresponding thereto, as shown in FIG. 7. The information is referenced to identify the device and necessary information corresponding to the acquired function candidate, and a request is made to collect the identified necessary information to the device management unit 1.

For example, when the function candidate acquired from the function estimation unit 7 is “search vicinity, within 1 km, convenience store,” the availability determination unit 5 identifies that the corresponding device is the car navigation system and the necessary information is the search result, and makes a request to the device management unit 1 so as to provide information on the search result around the convenience store existing within 1 km to the car navigation system.

Additionally, if there is one device controlled by the information providing device of the invention, it suffices to specify only the necessary information corresponding to each function candidate. Further, in the case where one function is configured of a plurality of devices or in the case where a plurality of pieces of necessary information exist for one function, it suffices to specify each device and each piece of necessary information.

Furthermore, in the case where the function candidate is always available, it suffices to specify the necessary information as “none.” That is, it suffices to carefully select and specify the information necessary for the availability determination described later. With these manners, efficient processing is possible.

The device management unit 1 acquires the information relating to the function candidate requested from the availability determination unit 5 in step ST701 from each corresponding device and outputs the acquired result to the availability determination unit 5 (step ST702).

For example, when the target device is the car navigation system and the function candidate of the determination target is “search vicinity, within 1 km, convenience store,” the device management unit 1 makes a request for the vicinity search to the convenience store existing within 1 km to the car navigation system, based on the request from the availability determination unit 5 in step ST701, and outputs the information of the search result to the availability determination unit 5.

As another example, in the case where the target device is the car navigation system and the function candidate of the determination target is “start FM, XY,” the device management unit 1 makes a request to check what the states are regarding the incoming signal strength of FM, the state of a set station, or the ON/OFF state of FM to the car navigation system, based on the request from the availability determination unit 5 in step ST701, and outputs the information of the obtained states to the availability determination unit 5.

As still another example, in the case where the target device is the vehicle or a device controlling the vehicle itself and the function of the determination target is “turn ON autocruise,” the device management unit 1 makes a request to check what the state is regarding the setting state of autocruise to the vehicle or the device controlling the vehicle, based on the request from the availability determination unit 5 in step ST701, and outputs information of the obtained state to the availability determination unit 5.

Incidentally, in this Embodiment 1, the information relating to the corresponding function of the corresponding device is configured to be acquired via the device management unit 1, but it is not limited thereto. For example, a similar effect can be obtained with a configuration in which the availability determination unit 5 is directly connected to the corresponding device to acquire information relating to the corresponding function of the corresponding device.

In addition, in the processing in this step ST702, results thereof are not seen by the user, but the processing is performed internally in order to acquire the information relating to the target function candidate subjected to the availability determination. Therefore, the load required for the processing in this step ST702 is desired to be small. For example, the car navigation system processes numerous operations that need to be performed by the car navigation system, such as calculation of the current position, route guidance, and update of traffic information. On the other hand, in the case where a destination setting is treated as the function to be provided to the user, the information relating to various facilities such as gasoline station, convenience store, family restaurant, and tourist site is involved. If all the information is to be acquired at once, the processing such as calculation of the current position, route guidance, or update of traffic information is expected to be delayed.

Alternatively, even when only the information of minimum requirements for the function estimation is acquired to perform the function estimation of the user, and then all the information relating to the various facilities not relevant to the result of the function estimation is acquired, a problem is produced. For example, if only the information necessary for the function estimation is acquired to perform the function estimation, going to the convenience store is estimated as a result, and then not only the convenience store but also all of the gasoline station, family restaurant, and the like are acquired, the load required for the processing is large.

That is, as the function candidates with the possibility of being provided increase, or as the information relevant to each function candidate increases, the acquisition of these information produces a problem. Therefore, like this Embodiment 1, with a configuration in which only the information necessary for function estimation is acquired to estimate the function candidate of the user, it is possible to reduce the load of the processing.

When the necessary information is acquired from the device management unit 1 in step ST702, the availability determination unit 5 determines the availability of the corresponding function, i.e., the function candidate identified by the function estimation unit 7, based on the determination reference prepared and stored in advance, regarding the information acquired from the device management unit 1 (step ST703).

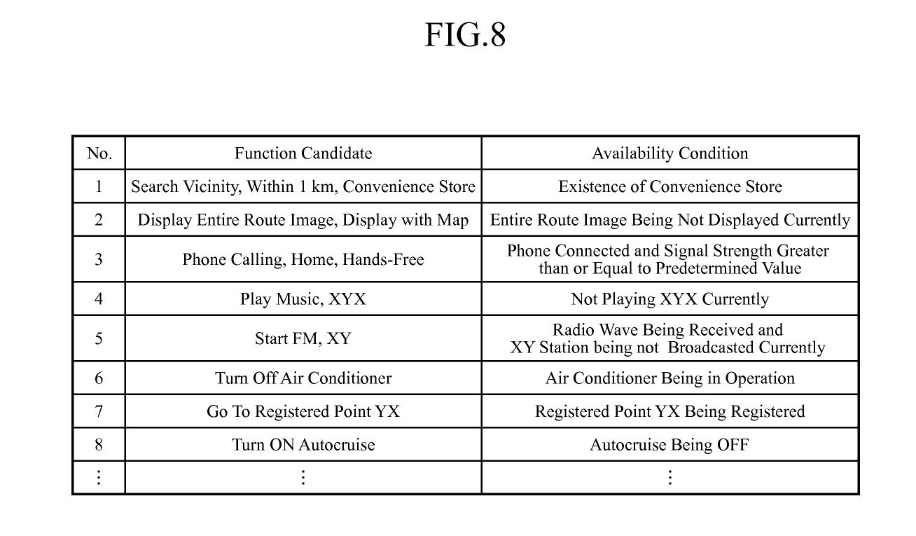

FIG. 8 is a diagram showing an example of a determination reference specifying a usage condition with respect to each function candidate. The availability determination unit 5 determines the availability based on the determination reference as shown in FIG. 8, regarding the information acquired from the device management unit 1 in step ST702.

For example, when the function candidate is “search vicinity, within 1 km, convenience store,” it is determined as unavailable if the convenience store does not exist in the information acquired from the device management unit 1 in step ST702, and it is determined as available in the case where the convenience store exists. In addition, in the case where the function candidate is always available, it suffices that the determination reference of that function candidate is provided with “none.”

Incidentally, in this connection, the determination reference is stored in advance in the availability determination unit 5. However, similar processing can be realized, when the determination reference is prepared in an external server connected to the information providing device and acquired by the availability determination unit 5 from the external server.

Accordingly, it is possible to check whether an estimated function is currently available or already in use. That is, it is possible to present the user with only the function available to the user or the function not yet in use.

Conversely, in the case where the estimated function is presented to the user as it is, a case may occur such that the function that cannot be used in that situation is presented. For example, consider a case where going to the nearby convenience store is estimated and the function to realize that estimation is presented to the user even though no convenience store exists near the host vehicle position. In this case, the convenience store existing far away from the host vehicle position may be presented when that function is selected by the user, which may correspond to the one that does not meet the intention of the user. Alternatively, it can occur that the user is informed that no convenience store exists nearby for the first time after the user selects that function.

Either way, convenience for the user is lost in these examples. Therefore, it is effective to present only the available function, as described in this Embodiment 1.

It is also conceivable that when various and numerous of information including the information in which the availability determination is possible is extracted in advance before the function estimation is performed, the function estimation is performed based on the extracted one such that the available functions are narrowed down. However, in this case, the numerous information need to be acquired at once, and the load of processing poses a problem as mentioned previously.

Finally, in step ST704, the availability determination unit 5 outputs the determination result of the availability in step ST703 to the function estimation unit 7 (step ST704), and the processing of the determination of availability of the acquired function candidate is ended. In other words, this means that the processing of step ST203 in FIG. 2 and step ST403 in FIG. 4 is ended.

In this manner, in the determination of availability in step ST403 (step ST701 to step ST704 in FIG. 6), predetermined information only of a function candidate of which the availability is to be determined is acquired, and whether the information meets the availability condition is examined.

That is, in step ST403 (step ST701 to step ST704 in FIG. 6), it is assumed that the availability determination is performed to only the function candidate with the highest probability that is selected in step ST401.

Taking as an example a case of providing a destination setting function, a facility with a high possibility of being provided is narrowed down to acquire its relevant information and determine the availability, instead of acquiring information relating to all facilities as a possible destination and verifying the availability thereof.

Therefore, it is a method with small processing load, and it is possible to present the user with only a function available to the user or a function not yet in use.

Return to the description of FIG. 4 again.

Following step ST403 (step ST701 to step ST704 in FIG. 6), the function estimation unit 7 acquires the determination result of the availability determination unit 5 in step ST403 and performs determination on whether or not the function candidate is available (step ST404). In the case where it is determined as “unavailable” in step ST404 (in the case of “NO” in step ST404), it returns to step ST401, and the processing in step ST401 to step ST403 mentioned previously is performed for the function candidate with the highest probability among the function candidates of which the availability is not determined. On the other hand, in the case where it is determined as “available” in step ST404 (in the case of “YES” in step ST404), it proceeds to step ST405.

When the function candidate is determined as available in step ST404, the function estimation unit 7 confirms that the function candidate determined as available is the function to be presented to the user (step ST405).

Additionally, in the case where the plurality of functions to be provided to the user are presented, it suffices to carry out step ST400 to step ST405 mentioned previously until a planned number of functions to be presented is obtained.

When the function estimation unit 7 confirms the function to be presented to the user in step ST405, the output unit 6 outputs the confirmed function (step ST406). Specifically, the confirmed function is displayed to the user in an image display unit of the information providing device. Further, it suffices for the user to select the function presented in the output unit 6 via an input unit not shown in the drawing. It suffices for the user to select the function presented from the output unit 6 via the input unit, although not shown in the drawing.

For example, three functions with higher probabilities of being desired by the user among the confirmed functions can be displayed in the image display unit of the information providing device such as the car navigation system, an instrument panel, or a head-up display. In addition, at that time, the corresponding three functions may be added by being read aloud and informed to the user through sound. Then, it suffices for the user to select the function desired by the user via the input unit. Note that this is merely an example, and the confirmed function may be notified to the user with another method.

Further, it may be configured such that the information providing device does not include the image display unit, and the output unit 6 transmits image display data and sound output data to an external display device.

Additionally, so far, there is described the case in which the device management unit 1 performs the processing (processing in step ST202 and after in FIG. 2) of acquiring the information from the connected device and selecting the function to be provided as the information, when the information providing device starts operating, i.e., when power is turned on; hereafter, in the case where the device management unit 1 acquires information from the connected device and detects a change in the state of the connected device, it suffices to perform the processing (processing in step ST202 and after in FIG. 2) of selecting the function to be presented as the information. Alternatively, the processing may be performed in an optional cycle.

As described above, of Embodiment 1, the function that has a high possibility of being desired by the user and also that is available can be carefully selected and provided to the user, even in the case where there are numerous function candidates to be provided to the user by the information providing device or in the case where there is a huge amount of information relating to the function candidates.

That is, even in the case where there are the numerous function candidates to be provided to the user or in the case where there is the huge amount of information relating to the function candidates, efficient processing is possible because the function with a high possibility of being desired by the user is narrowed down and subjected to the availability determination. In such a way, the function can be presented with good timing according to a change in the situation of the vehicle that changes continuously.

Further, since the function with a high possibility of being desired by the user is narrowed down and subjected to the availability determination, the processing load for acquiring the information relevant to a function desired by the user is small, and there is also an effect that an operation to be originally performed by the device controlled by the information providing device, for example, road guidance related to the car navigation system etc., can be performed stably.

Thus, the information providing device of Embodiment 1 of the invention is applicable to various types of devices, and becomes more effective as the function candidates to be provided to the user increase or as the information relating to the function candidates increase. In addition, it is possible to present reliably the available function with the efficient processing.

Besides, an on-board information apparatus is described as an example of the information providing device in the embodiment described later, but it is not limited thereto.

### Embodiment 2

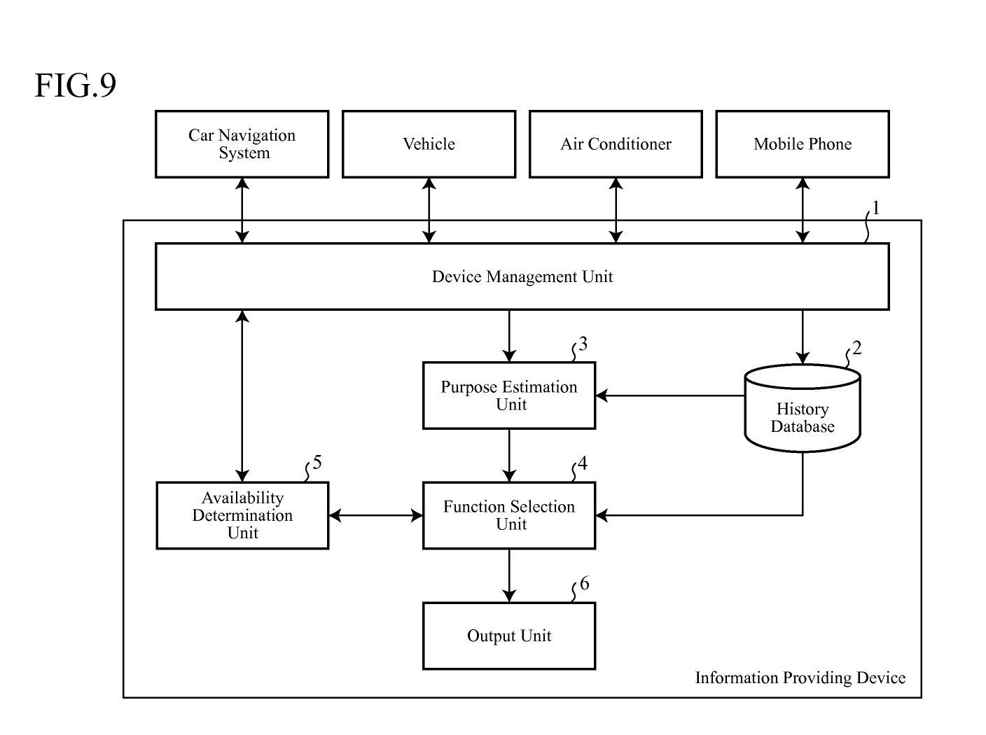

FIG. 9 is a block diagram showing a configuration of a main part of an information providing device of Embodiment 2 of the invention.

Regarding configurations similar to the information providing device shown in FIG. 1 in Embodiment 1, redundant descriptions will be omitted. The information providing device of Embodiment 2 differs from the information providing device shown in FIG. 1 in Embodiment 1 only in that the function estimation unit 7 is not included, and that a purpose estimation unit 3 and a function selection unit 4 are included. In Embodiment 1, the function estimation unit 7 performs the function selection. However, in Embodiment 2, purpose estimation and the function selection are separately performed by the purpose estimation unit 3 and the function selection unit 4, respectively.

An operation of the information providing device in Embodiment 2 will be described below. Redundant descriptions regarding operations similar to those of Embodiment 1 will be omitted.

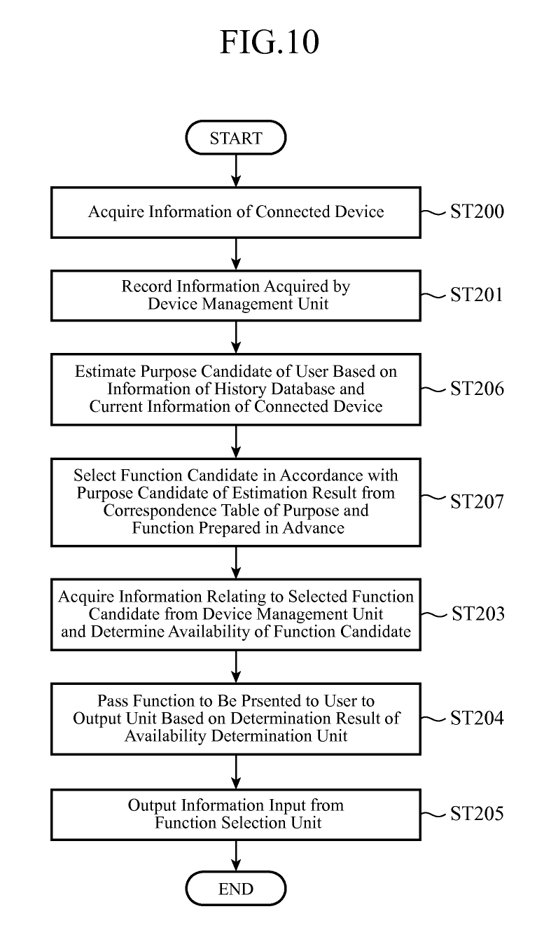

FIG. 10 is a flowchart for illustrating a main operation of the information providing device of Embodiment 2. Note that regarding steps similar to those shown in FIG. 2 in Embodiment 1, detailed descriptions will be omitted, and that only steps different from FIG. 2 will be described.

Steps ST200 to ST201 in FIG. 10 are similar to step ST200 to step ST201 in FIG. 2.

The purpose estimation unit 3 estimates a purpose candidate of a user under the situation, based on information of the history database 2 and information of a connected device acquired in step ST200 by the device management unit 1 (step ST206). Note that the estimated purpose candidate is given a probability or a degree of likelihood. For calculation of the degree of likelihood, it suffices to use a known method, e.g. conditional probability such as the Bayes' theorem. It is not limited thereto.

The function selection unit 4 selects a function candidate corresponding to the purpose candidate of the user acquired from the purpose estimation unit 3 in step ST206, based on a correspondence table prepared and stored in advance regarding a purpose and a function (step ST207). Then, the selected function candidate is output to the availability determination unit 5. Note that details of the selection of the function candidate will be described later.

After that, the availability determination unit 5 acquires, from the device management unit 1, information corresponding to the function candidate acquired from the function selection unit 4 in step ST203 and determines the availability of the function candidate selected by the function selection unit 4 in step ST207 (step ST203). The specific processing is similar to step ST203 in FIG. 2. In step ST203, the availability determination unit 5 outputs the availability determination result to the function selection unit 4.

The subsequent processing in step ST204 and step ST205 is also similar to step ST204 and step ST205 in FIG. 2.

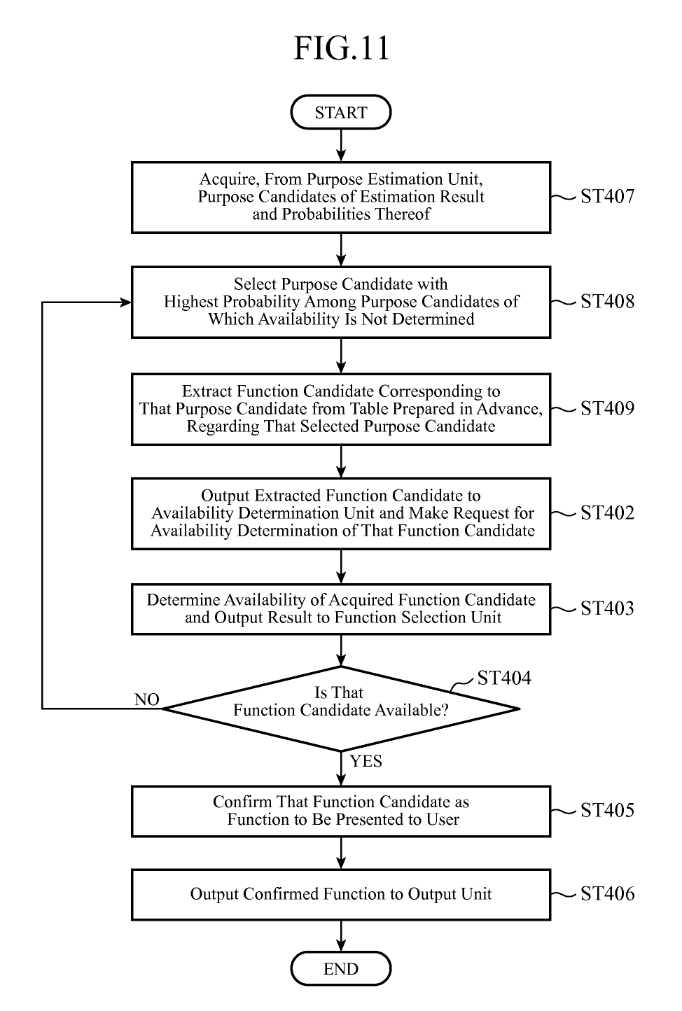

FIG. 11 is a flowchart illustrating a detailed operation in the selection of the candidate of function and availability determination therefor by the function selection unit 4 and the availability determination unit 5. Specifically, the processing in step ST207 to step ST204 in FIG. 11 is illustrated in detail. Note that regarding steps similar to those shown in FIG. 4 in Embodiment 1, detailed descriptions will be omitted, and that only steps different from those of FIG. 4 will be described.

The function selection unit 4 acquires the purpose candidate of the estimation result and the probability of being desired by the user from the purpose estimation unit 3 (step ST407).

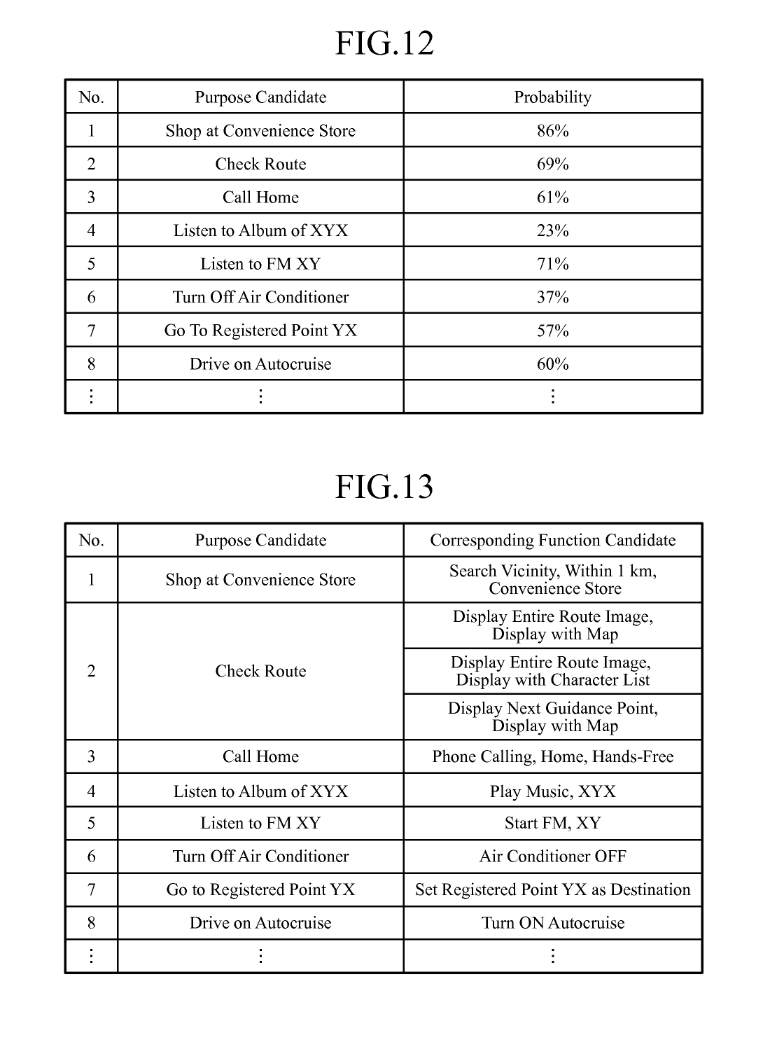

FIG. 12 shows an example of the estimation result acquired from the purpose estimation unit 3. It is calculated by the purpose estimation unit 3. Purpose candidates of No. 9 and after are omitted.

As shown in FIG. 12, the estimation result calculated by the purpose estimation unit 3 is the probability of being desired by the user that is given to each purpose candidate for all of the purpose candidates of the user targeted by the information providing device in a manner such as 86% probability of being desired by the user for a purpose candidate “shop at convenience store,” for example.

Note that in the description below, purpose candidates of No. 9 and after omitted in FIG. 12 are assumed as only purpose candidates with a probability below 30%.

The function selection unit 4 selects a purpose candidate with the highest probability among the estimation results acquired in step ST407 (step ST408). For example, in the example of the estimation result in FIG. 12, the probability of the purpose candidate “shop at convenience store” is the highest at 86%, and therefore the purpose candidate “shop at convenience store” is selected as the target of performing availability determination.

Additionally, in the case of transitioning from step ST404 described later, a purpose candidate with the highest probability among the purpose candidates excluding the purpose candidate of which the availability determination is performed is selected as the target of performing availability determination. For example, if the availability determination to the purpose candidate “shop at convenience store” is already performed, the availability determination is performed for “listen to FM XY” with the second highest probability.

Regarding the purpose candidate selected in step ST408, the function selection unit 4 extracts a function candidate corresponding to the purpose candidate from the table prepared and stored in advance (step ST409).

FIG. 13 is a diagram showing an example of the table prepared and stored in advance in the function selection unit 4. As shown in FIG. 13, for example, the function candidate “search vicinity, within 1 km, convenience store” is associated with the purpose candidate “shop at convenience store.” In step ST409, this function candidate is extracted.

Additionally, a function to be selected may also be a case expressed using the function itself such as “search vicinity” or a parameter upon executing the function such as “within 1 km”; however, there is also a case where the parameter is not given like No. 6 “air conditioner OFF” in FIG. 13. In addition, there may be a case where a purpose candidate and a function candidate are approximately the same. For example, “turn off air conditioner” and “air conditioner OFF” in No. 6 in FIG. 13 can be considered approximately the same.

In addition, similar processing can be realized, when the table in which the function candidate corresponding to the purpose candidate is prepared in advance is prepared in an external server connected with the information providing device instead of being stored in the function selection unit 4, and the function selection unit 4 acquires the table from the external server.

In addition, in FIG. 13, an example in which a purpose candidate and the corresponding function candidate are in a one-to-one relationship is mainly shown. However, a plurality of function candidates corresponding to one purpose candidate may exist. For example, a plurality of function candidates such as “display entire route image, display with map,” “display entire route image, display with character list,” and “display next guidance point, display with map” may correspond to a purpose candidate “check route” like No. 2 in FIG. 13

In the case where the plurality of function candidates corresponding to the one purpose candidate exist, it suffices to reference the operation history of the history database 2 and select a function candidate with the highest operation frequency. Alternatively, a function candidate with the highest possibility of being performed may be estimated and obtained from among the plurality of existing function candidates, using a known method, e.g., conditional probability such as the Bayes' theorem, like the processing performed by the purpose estimation unit 3.

As mentioned above, when there is provided with the purpose estimation unit 3 and the function selection unit 4, upon application to various products, it is possible to use the purpose estimation unit 3 as a common portion and makes the function selection unit 4 correspond to an individual product. That is, it suffices for the purpose estimation unit 3 to estimate a purpose candidate desired by the user under that situation, without being dependent on the type of function included in a product to which the information providing device according to the invention is applied. A difference in the function type that is dependent on the product to which the invention is applied can be dealt with by the function selection unit 4.

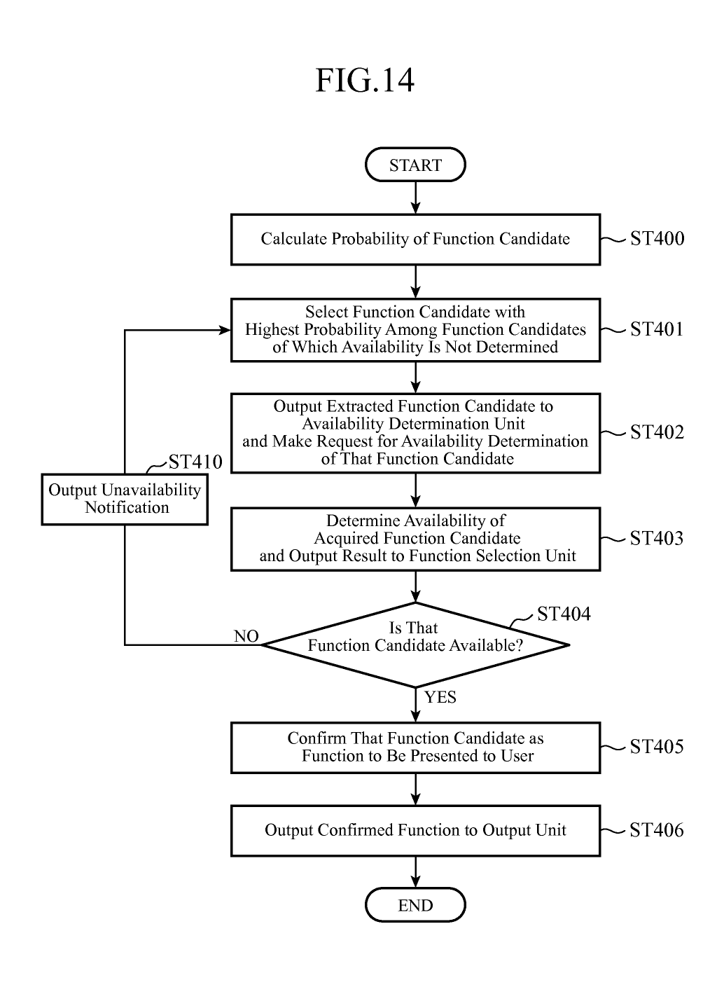

When a function corresponding to a purpose candidate output by the purpose estimation unit 3 does not exist in a product to which the information providing device according to the invention is applied, it suffices to assume that a corresponding function candidate is absent in the table shown in FIG. 14.

Accordingly, the whole need not be newly developed upon applying the information providing device according to the invention to various products, and efficient development is possible.

Return to the flow in FIG. 11.

The function selection unit 4 outputs a function candidate corresponding to a purpose candidate with the highest probability to the availability determination unit 5 and makes a request for availability determination of the selected function candidate (step ST402). The specific processing is similar to that performed by the function estimation unit 7 in step ST402 in FIG. 4.

The availability determination unit 5 performs determination of the availability of the function candidate acquired from the function selection unit 4 in step ST402 (step ST403). The specific processing is similar to step ST403 in FIG. 4. The availability determination unit 5 acquires the function candidate to be subjected to determination from the function selection unit 4 and performs processing according to the flowchart shown in FIG. 6.

The processing in step ST404 to step ST406 is similar to the processing in step ST404 to step ST406 in FIG. 4.

Regarding FIG. 14 mentioned previously, a complementary description will be given on a case where a plurality of function candidates corresponding to one purpose candidate exist. Although the operation for this case is not shown in the drawing, it suffices to proceed to step ST402 and determine the availability of another function candidate, in the case where the result of availability determination in this case is “unavailable.” After determining the availability for all function candidates corresponding to the purpose candidate selected in step ST408, it suffices to proceed to step ST408 if a function candidate that is “available” does not exist.

Accordingly, if a plurality of function candidates exist for a purpose candidate with the highest probability, the possibility that a function to realize the purpose candidate can be provided increases. That is, function estimation of high convenience is possible, since an alternative proposal for a function desired by the user can be provided.

As described above, a more simplified configuration is possible with Embodiment 2. Therefore, in the case where a change in the product type or function to which the present invention is applied is small, efficient development is rather possible.

### Embodiment 3

In Embodiments 1 and 2, an available function is selected and output to the output unit 6. However, in the case where a candidate of function is unavailable, an action is not taken.

Also in a conventional information providing device, it is configured such that unavailability cannot be informed to a user, in the case where a function estimated to be desired by the user under a certain situation is unavailable under that situation. There are cases where that function is useful information for the user. That is, there are cases where one wants to know that a function desired by a user under the certain situation is unavailable in the situation.

Thus, in this Embodiment 3, an embodiment will be described in which, if there is an unavailable function, that effect is output to be notified to a user.

Since the configuration of an information providing device of Embodiment 3 is similar to that described in Embodiment 1, redundant description is omitted.

FIG. 14 is a flowchart illustrating the detailed operation in the selection of a candidate of function and the availability determination by the function estimation unit 7 and the availability determination unit 5 in Embodiment 3.

Regarding processing similar to that shown in FIG. 4 in Embodiment 1, description thereof will be omitted. In this Embodiment 3, only the operation in step ST410 in FIG. 14 is added to Embodiment 1.

In the case where the function estimation unit 7 determines that a function candidate is not available in step ST404 (in the case of “NO” in step ST404), the function estimation unit 7 outputs, to the output unit 6, a notification with the content that the function candidate is currently unavailable (step ST410). Note that the function estimation unit 7 does not output the notification if the function is already in use. For example, even if a music piece XY is already being listened to and the music piece XY is not assumed as available in step ST403, an output is not made in this case.

Additionally, regarding an output method of the output unit 6, it suffices to cause display in an image display unit of the information providing device, such as a car navigation system, an instrument panel, or a head-up display, for example. At that time, the unavailability of the corresponding function may be additionally read aloud and informed to the user through sound. This is merely an example, and a confirmed function may be notified to the user with another method. It may be configured such that the information providing device does not include the image display unit, and that the output unit 6 transmits image display data and sound output data to an external display device.

Besides, in this case, description is given on the assumption that the configuration of the information providing device is similar to that described in Embodiment 1. However, the configuration described in Embodiment 2, i.e., the configuration including the purpose estimation unit 3 and the function selection unit 4 shown in FIG. 9 is also acceptable. In that case, it suffices to perform the processing in step ST410 described above after the processing in step ST404 in FIG. 11.

With this Embodiment 3, as described above, there is an effect that the user can know that a desired function under a certain situation is unavailable in the situation, and searching by the user himself on purpose can be avoided.

### Embodiment 4

In Embodiments 3, a notification is made accordingly in the case where a function is unavailable. However, notification is not made even if it becomes available later. Thus, in this Embodiment 4, an embodiment will be described in which availability is notified in the case where a function that has been unavailable becomes available.

Since the configuration of an information providing device of Embodiment 4 is similar to those described in Embodiments 1 and 3, redundant description thereof will be omitted.

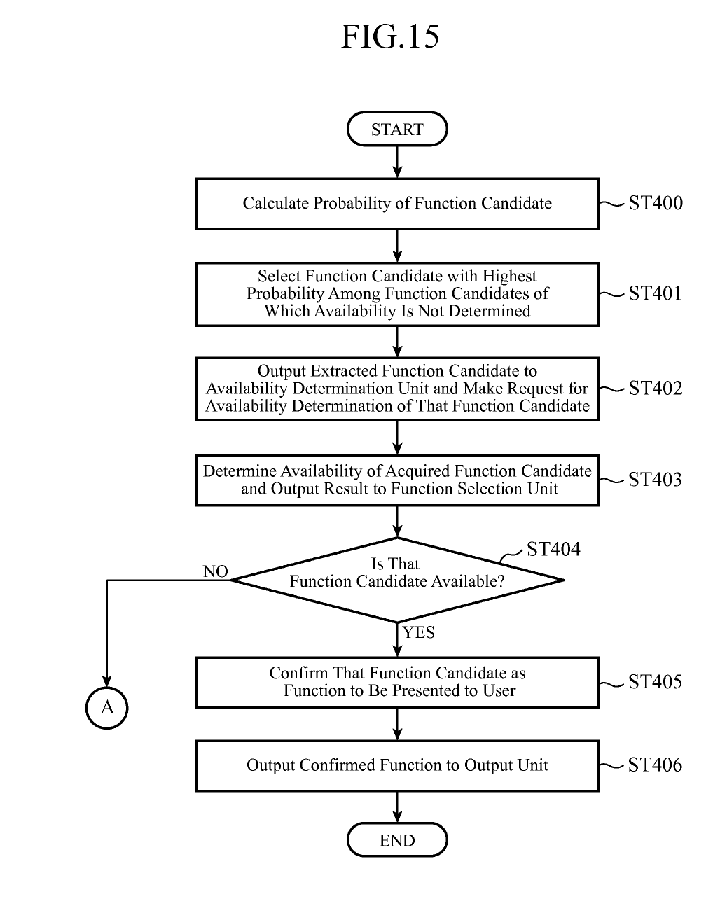

FIG. 15 is a flowchart illustrating detailed operations in selection of a candidate of function and availability determination therefor by a function estimation unit 7 and an availability determination unit in Embodiment 4.

Regarding processing similar to that shown in FIG. 14 in Embodiment 3, description thereof will be omitted.

The processing in step ST400 to step ST404 in FIG. 15 is similar to the processing in step ST400 to step ST404 in FIG. 14.

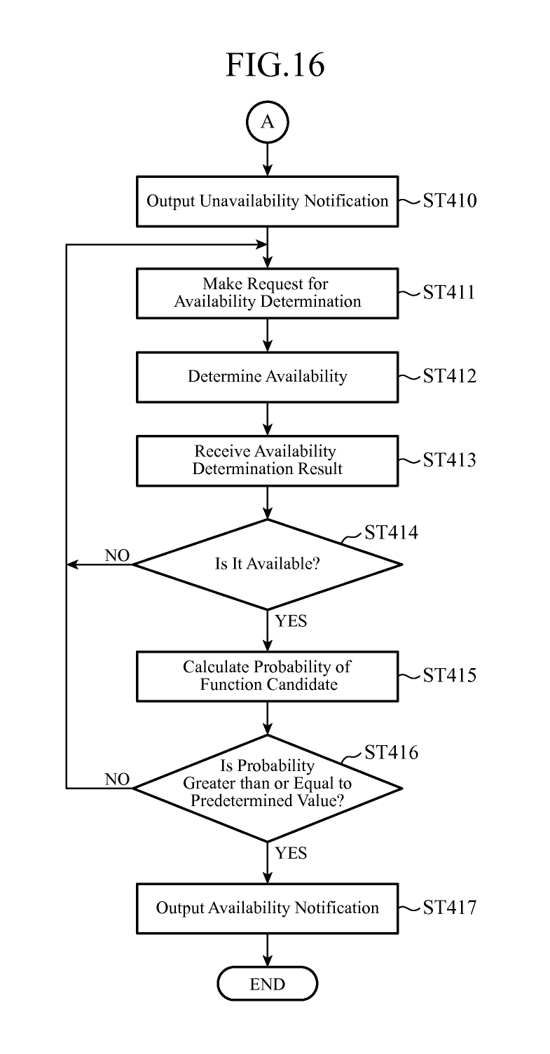

In the case where the function estimation unit 7 determines that a function candidate is unavailable in step ST404 (in the case of “NO” in step ST404), it proceeds to the processing shown in FIG. 16 (A in FIG. 15).

FIG. 16 is a flowchart illustrating the operation of monitoring whether a function candidate determined as unavailable becomes available later.

The function estimation unit 7 outputs to the output unit 6 a notification with the content that the function candidate (hereinafter, corresponding function candidate) determined as unavailable in step ST404 is unavailable (step ST410). The processing in step ST410 in FIG. 16 is similar to the processing in step ST410 in FIG. 14.

When the notification with the content of unavailability is output in step ST410, the function estimation unit 7 makes a request to the availability determination unit 5 again for availability determination on whether or not the function candidate (hereinafter, corresponding function candidate) determined as unavailable in step ST404 is available (step ST411).

The availability determination unit 5 makes a request for current information relating to the corresponding function candidate to the device management unit 1 and performs availability determination based on the acquired information (step ST412), and the function estimation unit 7 acquires the availability determination result from the availability determination unit 5 (step ST413). Note that the specific processing content in step ST411 to step ST413 is similar to step ST402 and step ST403 in FIG. 15 and the content described using FIG. 6.

When the determination result is acquired from the availability determination unit 5 in step ST413, the function estimation unit 7 determines whether or not the corresponding function candidate becomes available (step ST414).

In the case where it is determined as unavailable in step ST414 (in the case of “NO” in step ST414), it returns to step ST411, and the processing in step ST411 to step ST414 is repeated until it becomes available.

On the other hand, in the case where it is determined as available in step ST414 (in the case of “YES” in step ST414), the function estimation unit 7 calculates the probability of the corresponding function candidate (step ST415). For a specific calculation method, it suffices to use a known method, e.g., conditional probability such as the Bayes' theorem, in a similar manner to the method described in step ST400 in FIG. 15.

The function estimation unit 7 determines whether or not the probability of the corresponding function candidate calculated in step ST415 is greater than or equal to a predetermined value (step ST416). That is, determination is performed on whether the function is estimated as being desirably performed by the user under the situation determined as becoming available. Note that it suffices to set the predetermined value in advance.

When it is determined that the probability of the corresponding function candidate is greater than or equal to the predetermined value in step ST416 (in the case of “YES” in step ST416), the function estimation unit 7 outputs a notification that the corresponding function candidate becomes available to the output unit 6. The output unit 6 outputs the notification received from the function estimation unit 7. Additionally, for an output method, it suffices to display it in an image display unit of the information providing device, such as a car navigation system, an instrument panel, or a head-up display, for example. At that time, the availability of the corresponding function may be additionally read aloud and informed to the user through sound. This is merely an example, and the confirmed function may be notified to the user with another method. In addition, it may be configured such that the information providing device does not include the image display unit, and that the output unit 6 transmits image display data and sound output data to an external display device.

On the other hand, in the case where it is determined that the probability of the corresponding function candidate is not greater than or equal to the predetermined value in step ST416 (in the case of “NO” in step ST416), it returns to step ST411, and the following processing is repeated.

Additionally, in this case, the configuration is provided such that once a function candidate is determined as unavailable (step ST404), it waits until the corresponding function becomes available (FIG. 16), but it is not limited thereto; it may be configured such that processing (processing in step ST401 to step ST406 in FIG. 15) relating to a function candidate with the second highest probability is performed in parallel with the processing of waiting until the corresponding function becomes available.

Besides, in this case, description is given on the assumption that the configuration of the information providing device is similar to that described in Embodiment 1. However, the configuration described in Embodiment 2, i.e., the configuration including the purpose estimation unit 3 and the function selection unit 4 shown in FIG. 9 is also acceptable. In that case, it suffices to perform the processing in FIG. 16 described above after the processing in step ST404 in FIG. 11.

According to Embodiment 4, as described above, the user can know that a function that has been unavailable becomes available. Therefore, the user need not remember a function that is currently unavailable or be aware of whether an unavailable function becomes available, and highly-convenient function estimation is possible.

### Embodiment 5

In Embodiments 1 to 4 described above, a case where the information providing device in the invention is applied to the on-board information equipment is described as an example. However, application is not limited to the on-board information equipment and may be to an information providing device for a moving object including a person, vehicle, railroad, ship, aircraft, or the like. Application is also possible to various types of devices, such as a home energy management system (HEMS), a device that controls a machine tool or electronic commerce such as Internet shopping, or a medical device. For example, consider a case where the invention is applied to the HEMS that controls various devices. As an example of a function to be presented, a function of setting an off timer of an air conditioner will be described as an example. In this case, it suffices to estimate a function candidate to set the off timer of the air conditioner, based on carefully selected information such as the time or operation history. Then, it suffices to check the operation state of the air conditioner that is a minimum requirement for determining the availability, such as, for example, whether the air conditioner is ON or whether the off timer is already set, and if the off timer is determined as available, to present that effect.

That is, it is not that all of the operation state of the air conditioner is acquired in advance to perform estimation of a function candidate. Therefore, efficient processing is possible. Since many devices are controlled in HEMS, there are many function candidates to be provided to a user, and there is a large amount of information relating to each function candidate. Therefore, the effect is further increased.

It may be applied to a server of a navigation system. It can be applied to any form such as an application of an information providing system installed in a mobile information terminal or the like such as a smartphone, tablet PC, or mobile phone.

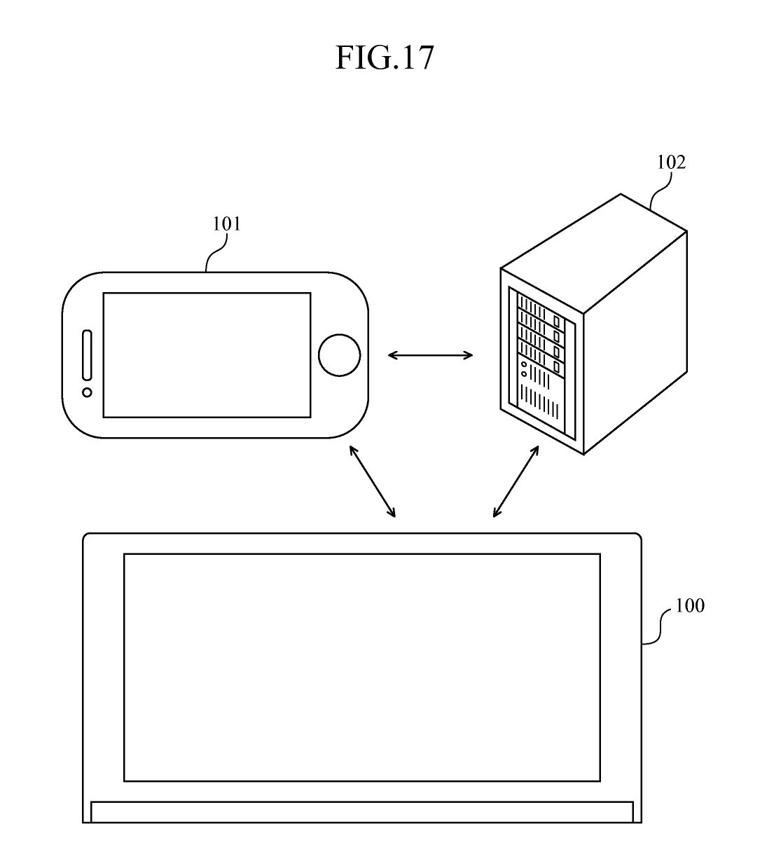

Here, FIG. 17 is a diagram showing the outline of a navigation system in Embodiment 5. The navigation system can take various forms, such as an on-board device 100 performing information providing processing in coordination with at least one of a mobile information terminal 101 such as a smartphone and a server 102, or at least one of the mobile information terminal 101 such as a smartphone and the server 102 performing information providing processing and causing the on-board device 100 to display the result. The configured form of that navigation system will be described below.

In Embodiments 1 to 4, description is given on the assumption that the on-board device 100 shown in FIG. 17 includes all of the functions of the information providing device of the invention. However, for the navigation system in this Embodiment 5, a case where the server 102 performs information providing processing and the result is provided to a user by being displayed in the on-board device 100 and a case where the mobile information terminal 101 performs information providing processing in coordination with the server 102 and the result is provided to the user by being displayed in the on-board device 100 will be described.

First, a case where the server 102 performs information providing processing and the on-board device 100 is caused to display the result, i.e., a case where the on-board device 100 functions as a display device in coordination with the server 102 including an information providing function will be described.

In this configuration, a case is conceivable in which the on-board device 100 directly communicates with the server 102 or the on-board device 100 communicates with the server 102 via the mobile information terminal 101. The server 102 functions as an information providing device including the device management unit 1, the history database 2, the purpose estimation unit 3, the function selection unit 4, the availability determination unit 5, and the function estimation unit 7 described in Embodiments 1 to 4 described above. The on-board device 100 functions as a display device including at least a communication unit with which information of a device connected to the on-board device 100 is transmitted to the server 102 and the output unit 6 for providing the user with the result of recognition by the server 102.

In this case, the on-board device 100 basically only includes a communication function and a display function, so that the information providing result from the server 102 is received and provided to the user.

That is, the server 102 is an information providing device excluding the output unit 6, and the server 102 that is the information providing device causes the on-board device 100 that is the display device to display a function that is determined through acquisition of information of the connected device.

With such a configuration, an effect similar to Embodiments 1 to 4 can be obtained.

A case where the mobile information terminal 101 performs information providing processing in coordination with the server 102 and the on-board device 100 provides the user with the result will be described.

In this configuration, a case is conceivable in which the on-board device 100 communicates with the server 102 via the mobile information terminal 101. An application of the mobile information terminal 101 performs the information providing processing in coordination with the server 102. The on-board device 100 functions as a display device including at least the output unit 6 for providing the user with the result from the mobile information terminal 101 and the server 102.

Also in this case, the on-board device 100 basically only includes a communication function and a display function, so that the information providing result from the coordination of the mobile information terminal 101 and the server 102 is received and provided to the user.

That is, the application of the mobile information terminal 101 causes the on-board device 100 that is the display device to display a function determined through acquisition of information of the connected device.

With such a configuration, an effect similar to Embodiments 1 to 4 can be obtained.

In the invention of the present application, a free combination of the respective embodiments, any modification of a component in each embodiment, or any omission of a component in each embodiment is possible within the scope of the invention.

### INDUSTRIAL APPLICABILITY

Since efficient processing is possible even in the case where a huge amount of information relevant to a function desired by a user exists, and a function can be presented at the right timing in accordance with a change in the situation of a vehicle that changes continuously, the information providing device according to the invention can be applied to an information providing device or the like that estimates the purpose of a user and provides the user with a function to realize that purpose of operation.

### DESCRIPTION OF REFERENCE NUMERALS AND SIGNS

1: Device management unit
2: History database
3: Purpose estimation unit
4: Function selection unit
5: Availability determination unit
6: Output unit
7: Function estimation unit
10: Information management unit
100: On-board device
101: Mobile information terminal
102: Server.

1. An information providing device comprising:
a device manager that acquires information of a connected device;
a history database that stores the information acquired by the device manager as a history;
a function estimator that estimates a function to be presented to a user, based on the information of the connected device and the history stored in the history database;
an availability determinator that determines availability of the function based on a determination condition of the availability corresponding to the function estimated by the function estimator; and
an output processor that presents the estimated function to the user when the availability determinator determines that the function estimated by the function estimator is available.

2. The information providing device according to claim 1, wherein the availability determinator determines the availability, based on only information relating to the function estimated by the function estimator.

3. (canceled)

4. The information providing device according to claim 1, wherein the function estimator includes:
a purpose estimator that estimates a purpose of the user; and
a function selector that selects a function corresponding to the purpose estimated by the purpose estimator.

5. The information providing device according to claim 4, wherein the function selector selects the function corresponding to the purpose estimated by the purpose estimator, based on a function candidate table in which the purpose and function are associated with each other.

6. The information providing device according to claim 4, wherein the function selector selects the function corresponding to the purpose estimated by the purpose estimator, based on the history stored in the history database.

7. The information providing device according to claim 1, wherein the function estimator causes the output processor to output a notification that the function is unavailable when the availability determinator determines that the estimated function is unavailable.

8. The information providing device according to claim 1, wherein the function estimator causes the output processor to output a notification that the function is unavailable when the availability determinator determines that the estimated function is unavailable, and requests the availability determinator again to perform availability determination of the function, and causes the output processor to output a notification that the function becomes available when the availability determinator determines that the function becomes available.

9. (canceled)

10. An information providing server comprising:
a communicator that acquires, from an on-board device, information of a device connected to the on-board device;
a history database that stores the information acquired by the communicator as a history;
a function estimator that estimates a function to be presented to a user, based on the information acquired by the communicator and the history stored in the history database; and
an availability determinator that determines availability of the function based on a determination condition of the availability corresponding to the function estimated by the function estimator,
wherein the function is determined the function to be presented to the user when the availability determinator determines that the estimated function is available.

11. An information providing method comprising:
a step in which a communicator acquires, from an on-board device, information of a device connected to the on-board device;
a step in which a function estimator estimates a function to be presented to a user, based on the information acquired by the communicator and a history stored in a history database storing the information acquired by the communicator as the history;
a step in which an availability determinator determines availability of the function based on a determination condition of the availability corresponding to the function estimated by the function estimator; and
a step in which an output processor presents the function to the user when the availability determinator determines that the estimated function is available.
